(19) United States
(12) Patent Application Publication
(10) Pub. No.: US 2023/0253748 A1
(43) Pub. Date: Aug. 10, 2023

(54) Method for Securing the Electrical Contacts in a Connector System

(71) Applicant: e-con Systems India Private Limited, Chennai (IN)

(72) Inventor: Deepan Chakravarthi N, Chennai (IN)

(73) Assignee: e-con Systems India Private Limited, Chennai (IN)

(21) Appl. No.: 17/667,042

(22) Filed: Feb. 8, 2022

(51) Int. Cl. H01R 43/02; H01R 12/57; B23K 1/00

(52) U.S. Cl. CPC H01R 43/0263; B23K 1/0016; H01R 12/57; H01R 43/0256; H01R 12/716

(57) ABSTRACT

The present invention relates to a PCB connector with SMT adhesive agent (102). The present invention further relates to a method to rigidly hold a connector housing (101) on a printed circuit board assembly, which comprises a connector housing (101) which is to be fixed to the printed circuit board during the PCB assembly process using the SMT adhesive agent (102). The primary advantage is a reliable board-to-board stacking connector assembly.

### FIELD OF INVENTION

The present invention focuses on a PCB connector with SMT adhesive agent. More particularly, in case of board-to-board stacking connectors, there is always a need to provide a reliable means to ensure the contacts between the matting terminals. This method also enables the use of multiple connectors with improved reliability of operation.

### BACKGROUND OF THE INVENTION

Surface mount technology is a technology for directly bonding electronic components to a printed circuit board. Compared to the previously used PIH (Pin-In-Hole) technology, the surface mount technology has several advantages such as easier design, lower process cost, and higher quality.

Such surface mounting technology may be implemented in a sequence of operations such as PCB loading, solder cream application, solder cream application inspection, component mounting, soldering, soldering inspection, and the like. Surface mount technology is expressed in English as Surface Mount Technology, and its abbreviation is often referred to as SMT. Proper mating of electrical contact terminals in the connector assemblies becomes unreliable during the frequent usage conditions where the connectors frequently matted and disconnected. This problem is more pronounced when there is more than one connector used between two electronic printed circuit board assemblies.

The connector pins are attached with its housing. During the usage i.e. assembling and disassembling, the mechanical movement of the matting connector lifts the connector housing (101), and the housing lifts the contact terminals.

Due to this mechanical action on the terminals, they are misaligning from its actual position in the connector housing (101). Also causing the physical damage to the connector housing (101), terminals and its solder joints.

The patent application WO2021075717A1 relates to a surface mount-type elastic electrical connector assembly. The surface mount-type elastic electrical connector assembly, according to one embodiment of the present invention, comprises: an elastic electrical connector (100) having a plurality of conductive patterns (22) formed on an electrically-insulating elastic body (10); and a stopper (200) which is coupled to the elastic electrical connector (100) and has a structure in which the stopper surrounds the elastic electrical connector (100) from the side and has an open top and bottom. The elastic electrical connector (100) performs an electrical communicator function between a lower PCB and an upper PCB, is SMT-joined on the lower PCB, and is in an elastic contact with the upper PCB.

The patent application FR2709634A1 relates to a structure for linking printed circuit cards together, of the type having an arrangement in which a part of the electrical link for a flexible printed circuit card comprising a thermoplastic film serving as substrate is made of soft electrodes, and the electrodes are directly and electrically linked to an electrode part of the other printed circuit card with an adhesive agent. The structure for linking the printed circuit cards together comprises a liquid, electrically insulating, thermosetting adhesive agent as adhesive agent. The electrodes are thermos-compressed onto one another.

Another patent application JP2006140052A provides a connector enabled to downsize a connecting part with connection reliability secured. The connector 10 is one for electrically connecting wiring boards, with the thermosetting adhesive film. The surface of terminal parts 2, 2′ of the connectors connected with electric connection parts of the wiring boards is of a structured surface 3, on which is a layer of the thermosetting adhesive film.

The present invention addresses the existing problem of interconnection between electronic printed circuit board assemblies.

The present invention discloses a method ensuring rigid fixing of the connector housing (101). By assuring the stability of the connector housing (101), the alignment of the connectors and its terminals are assured, providing the reliable electrical contacts between the terminals of the matting connectors.

### OBJECTIVE OF THE INVENTION

The main objective of our system is to provide multiple connections required between one PCB assembly to other PCB assembly, particularly in case of board-to-board stacking connectors, there is always a need to provide a reliable means to ensure the contacts between the matting terminals.

Another objective of the present invention is to ensures rigid fixing of the connector housing (101). By assuring the stability of the connector housing (101), the alignment of the connectors and its terminals are assured, providing the reliable electrical contacts between the terminals of the matting connectors.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing and the claims and the abstract, as a whole.

The present invention includes rigid fixing of the connector housing (101).

In one aspect of the invention the connector housing (101) is to be fixed during the PCB assembly process using the SMT adhesive agent.

In another aspect of the invention the SMT adhesive agent holds the connector housing (101) with the PCB.

In another aspect of the invention during the assembly process, the connector housing (101) is provided with the SMT glue or similar adhesive agents for holding the connector housing (101). When the soldering operation takes place, the adhesive agent cures and affixes the housing and the PCB rigidly.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The manner in which the proposed system works is given a more particular description below, briefly summarized above, may be had by reference to the components, some of which is illustrated in the appended drawing. It is to be noted; however, that the appended drawing illustrates only typical embodiments of this system and are therefore should not be considered limiting of its scope, for the system may admit to other equally effective embodiments.

Throughout the drawings, the same drawing reference numerals will be understood to refer to the same elements and features.

The features and advantages of the present proposed system will become more apparent from the following detailed description along with the accompanying figures, which forms a part of this application and in which:

FIG. 1: represents the front side (1a) and the rear side (1b) connector housing (101) with the PCB in accordance with our present invention; and

FIG. 2: represents the PCB 1 and PCB 2 in accordance with our present invention.

### REFERENCE NUMERALS

Connector housing (101)
SMT Adhesive (102)
Contact terminal (201) of connector housing (101) soldered to the PCB 1
Mating connector housing (202)
Contact terminal of mating connector housing (202) soldered to the PCB 2

### DETAILED DESCRIPTION OF THE INVENTION

The principles of operation, design configurations and evaluation values in these nonlimiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are construed such that it provides a complete and a thorough understanding of the disclosed invention, by clearly describing the scope of the invention, for those skilled in the art.

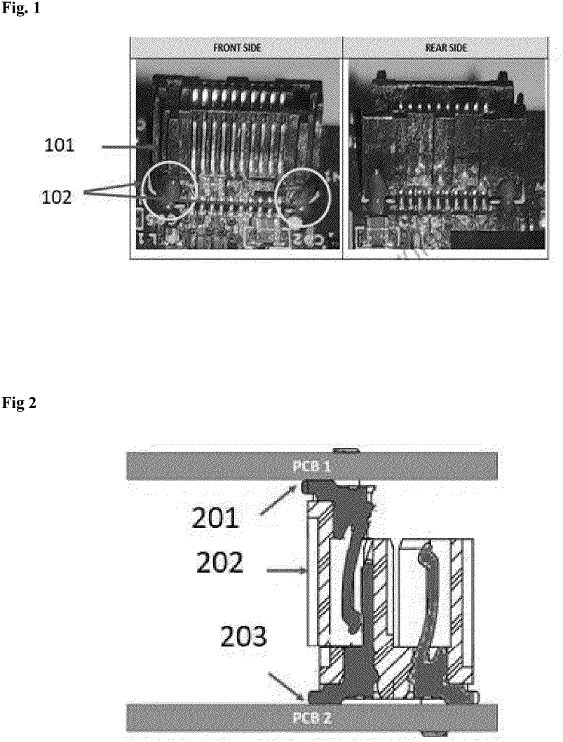

The present invention relates to a method to rigidly hold a connector housing (101) on a printed circuit board assembly. The present invention as illustrated in FIGS. 1 and 2 where the connector housing (101) is secured or fixed during the PCB assembly process using an SMT Adhesive (102) agent or the like. No separate curing is required other than the subsequent soldering process. The present invention includes a contact terminal (201) of the connector housing (101) to be soldered to the PCB 1 and a contact terminal soldered (203) of the mating connector housing (202) to be soldered the PCB 2 (203). Thus, a connection is established between the mating connector housing (202) and the connector housing (101) so that an electrical connection is established between the contact terminal (201) soldered to PCB1 and the contact terminal (202) soldered to PCB2. As a result, an electrical connection is estabished between PCB1 and PCB 2 through the contact terminal (201) soldered to PCB1 and the contact terminal (202) soldered to PCB2.

With the implementation of the above method, the terminals (201) are held firmly and are aligned to provide the reliable contacts. The connectors assembled by this method work reliably even for the multiple mating cycles of the connectors. Intermittent connectivity problems faced due to misalignment and damage of terminals is eliminated. The present invention includes a method of assembly fixing of connectors with the SMT glue at the selected locations.

The present invention includes a reliable board to board stacking connector assembly. The present invention also allows the use of multiple connectors for PCB stacking. Connector holding on to the PCB prevents its movement with respect to its mating connector and provides electrical contact positioning with respect to its mating connector.

The present invention relates specifically to a method of assembly, fixing of connectors with the SMT glue at the selected locations.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method for securing electrical contacts of terminals in a connector system comprising the steps of:
rigidly holding a connector housing (101) on the printed circuit board assembly;
wherein the connector housing (101) is rigidly held to the printed circuit board assembly using SMT adhesive (102); and
soldering terminals of the connector housing for electrical contact with the printed circuit board.

2. The method for securing electrical contacts of terminals in a connector system as claimed in claim 1, wherein the connector housing (101) is fixed to the printed circuit board during the printed circuit board assembly process.

3. The method for securing electrical contacts of terminals in a connector system as claimed in claim 1, wherein the terminals are held firmly and are aligned to provide reliable contacts.

4. The method for securing electrical contacts of the terminals in a connector system as claimed in claim 1, wherein connectors assembled by this method work reliably even for multiple mating cycles of the connectors.
